(19) United States
(12) Patent Application Publication
(10) Pub. No.: US 2015/0328085 A1
(43) Pub. Date: Nov. 19, 2015

(54) Teething Bib

(71) Applicant: Tracy Richards, Queens Village, NY (US)

(72) Inventor: Tracy Richards, Queens Village, NY (US)

(21) Appl. No.: 14/711,957

(22) Filed: May 14, 2015

Related U.S. Application Data
(60) Provisional application No. 61/992,990, filed on May 14, 2014.

(51) Int. Cl. A61J 17/02; A41B 13/10

(52) U.S. Cl. CPC A61J 17/02; A41B 13/10

(57) ABSTRACT

A teething bib is provided configured to be worn around a neck of an infant to protect clothing worn by the infant from spilled food, drinks, and excess drool due to teething. The teething bib includes a body portion having an upper portion, a lower portion, an exterior surface, a coextensive interior surface, and an outer edge therearound. The body portion includes a pair of flaps that are wrapped and removably fastened around an infant's neck. The exterior surface of the body portion further includes a front portion that is removably attached to provide a second layer of protection. The lower portion includes at least one teether configured to be placed within an infant's mouth to sooth and ease pain due to teething.

### CROSS REFERENCE TO RELATED APPLICATION

This application claims the benefit of U.S. Provisional Application No. 61/992,990 filed on May 14, 2014. The above identified patent application is herein incorporated by reference in its entirety to provide continuity of disclosure.

### BACKGROUND OF THE INVENTION

### Field of the Invention

The present invention relates to baby accessories. More specifically, the present invention pertains to an improved teething bib that is configured to sooth and ease pain while an infant is teething.

Bibs are the first line of defense in keeping infants and their clothing dry and free of food particles. There are many types of bibs such as feeding bibs and teething bibs. Feeding bibs are used to protect clothing from food and liquids while feeding an infant, while teething bibs can also be used to protect clothing during meals, they are primarily used to provide protection for drooling due to teething. Generally, teething bibs are used to prevent drool from seeping through the bib fabric and reaching clothes worn by the infant.

Some teething infants will munch on anything he can get his hands on. One of the first signs of teething in an infant is drooling. An excess level of drooling can wet their clothing and skin, which can cause the infant to become fussy and require a change of clothes. Many infant bibs have been known in the prior art for many years, these bibs have had various articles attached thereon such as toys, playthings, and pacifiers. Other bibs integrate teething material directly into the bib. However, there exists a need for a bib that includes teethers configured to soothe an infant and ease their pain due to teething.

The present invention provides a teething bib configured to be worn around the neck of an infant to protect clothing worn by the infant from spilled food, drinks, and excess drooling. The teething includes a preferably rectangular shaped body portion having an upper portion, a lower portion, an exterior surface, a coextensive interior surface and an outer edge therearound. The upper portion includes a pair of flaps attached to the outer edge therearound configured to wrap and removably fasten therearound an infant's neck by a first fastener. The exterior surface includes a front portion that is removably fastened by a second fastener configured to provide a second layer of protection for the infant's clothing. In the case, the front portion becomes wet, the front portion can be detached from the exterior surface. The lower portion includes at least one teether attached thereon configured to sooth and ease pain of an infant due to teething.

### SUMMARY OF THE INVENTION

In view of the foregoing disadvantages inherent in the known types of teething bibs now present in the prior art, the present invention provides a new and improved teething bib wherein the same can be utilized for soothing an infant's pain while teething.

It is therefore an object of the invention to provide a new and improved teething bib that has all of the advantages of the prior art and none of the disadvantages.

Another object of the present invention is to provide a new and improved teething bib comprising a body portion having an upper portion, a lower portion, an exterior surface, a coextensive interior surface, and an outer edge therearound.

Yet another object of the present invention is to provide a new and improved teething bib, wherein said upper portion includes a pair of flaps configured to wrap and removably fasten around an infant's neck

Still yet another object of the present invention is to provide a new and improved teething bib, wherein said exterior surface includes a front portion that is removably attached by a fastener.

A further object of the present invention is to provide a new and improved teething bib, wherein said lower portion includes at least one teether configured to be placed within an infant's mouth to sooth and ease pain due to teething.

Yet a further object of the present invention is to provide a new and improved teething bib, wherein said at least one teether is evenly spaced apart along the outer edge of the lower portion.

Still yet another object of the present invention is to provide a new and improved teething bib wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a front perspective of the present invention.

FIG. 2 shows a second front perspective of the present invention.

### DETAILED DESCRIPTION OF THE INVENTION

References are made herein to the attached drawings. Like reference numerals are used throughout the drawings to depict like or similar elements of the teething bib. For the purposes of presenting a brief and clear description of the present invention, the preferred embodiment will be discussed as wrapped and removably fastened around an infant's neck to protect clothing worn by the infant and sooth pain from teething. The figures are intended for representative purposes only and should not be considered to be limiting in any respect.

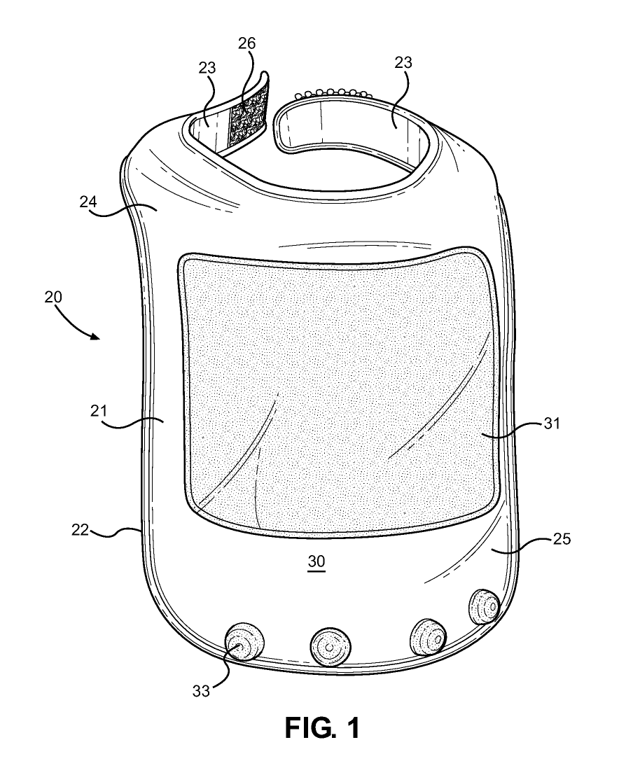

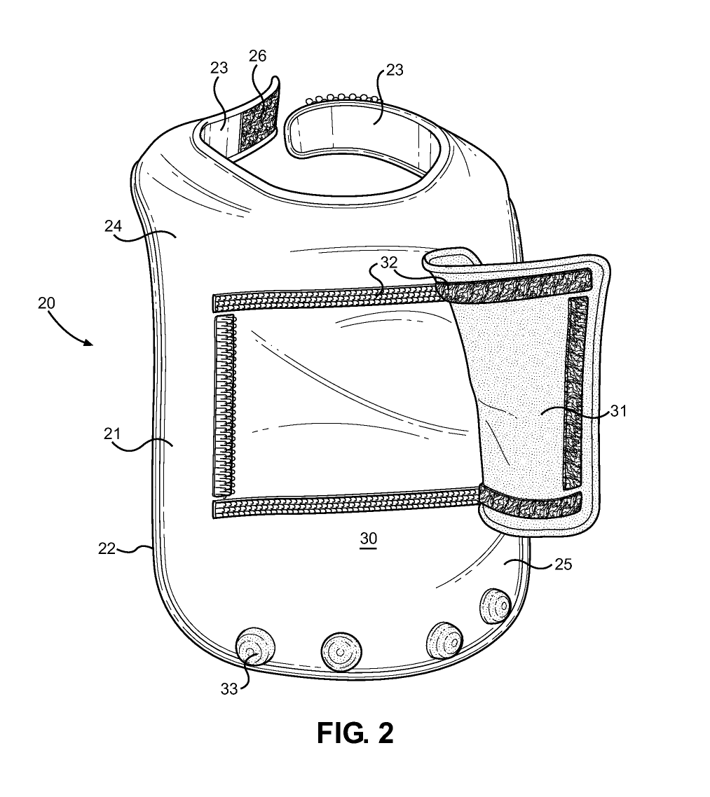

Referring now to FIGS. 1 and 2, there are shown a pair of front perspectives of the teething bib 20. The teething bib 20 is configured to be worn around the neck of an infant to protect clothing from spilled food and drinks. In addition, the bib 20 is configured to provide infants with teethers that help soothe the infant's pain. The bib 20 includes a body portion 21 having an upper portion 24, a lower portion 25, and an outer edge 22 therearound. The upper portion 24 includes a pair of flaps 23 each having a first end 27 and a second end 28. The first end of each flap 23 is attached along the outer edge 22 of the body portion. The flaps 23 are configured to be wrapped around the infant's neck and removably fastened by a first fastener 26 on the second ends 28 of the flaps 23 to prevent food and drinks to be spilled on clothing worn by the infant.

Preferably, the body portion 21 is substantially a rectangular shape, however, it is contemplated that the body portion can include a variety of shapes and sizes as well as various textures and colors. In addition, as readily recognized by one of ordinary skill with the present disclosure before them, it is contemplated that the first fastener 26 can include a variety of suitable types of fasteners 26 including, but not limited to hook and loop fasteners and button fasteners.

The body portion 21 includes an interior surface and an exterior surface 30. The interior surface is configured to be placed against the infant's chest and torso, thereby using the exterior surface 30 to protect clothing from spilled food and drinks. The exterior surface 30 includes a front portion 31 that is removably fastened to the exterior surface 30 by a second fastener 32. The second fastener 32 is preferably a hook and loop fastener, however, alternative embodiments utilize other suitable fasteners that allow the front portion 31 to be removably attached. In this way, the front portion 31 provides a second layer of protection for the infant's clothing. The front portion 31 is particularly advantageous when the front portion 31 becomes too dirty and/or too wet, the front portion 31 can simply be detached, wherein the area underneath the front portion 31 can serve as a fresh layer of protection. Preferably, the front portion is composed of a lightweight fabric that is washable, however alternative materials such as thermoplastic or thermoset material are contemplated. It is likewise contemplated that the front portion 31 can include various colors, sizes, textures, and sizes.

The lower portion 25 includes at least one teether 33 configured to be placed within an infant's mouth to calm and sooth infants while they are teething. The teethers 33, in the illustrated embodiment, are substantially rounded protrusions that are evenly placed apart and along the outer edge 22 of the body portion 21, however alternative embodiments may be alternatively composed of other shapes and sizes of teethers 33. Preferably, the teethers 33 are composed of a non-toxic rubber that does not erode during the teething process. Moreover, the teethers 33 are preferably a lightweight rubber to minimize the strain on the bib 20 upon an infant's neck. While suitable materials include polypropylene, ethylene vinyl acetate (EVA) and latex rubber, other materials as would be known by those of ordinary skill in the art with the present disclosure before them are likewise contemplated.

The teethers 33 are preferably molded onto the exterior surface 30 of the lower portion 25 to ensure that an infant is precluded for tearing the teethers 33 from the body portion 21. However, it is similarly contemplated that the teethers 33 may be sewn into the lower portion 25, or snapped on to ensure an integrated fit onto the teething bib 20. As shown in the illustrated drawing, the lower portion 25 includes four teethers 33 however, it is important to note that although a plurality of teethers 33 is contemplated to be affixed thereon, it is equally important that the weight of the teething bib 20 remains light as not to place undue strain on an infant's neck.

The outer edge 22 includes a thick border that is preferably bound therearound by stitching, fabric tape, or a combination thereof to reinforce the outer edge 22 against erosion or fraying. The border is particularly effective in preventing food, drinks, or an infant's saliva from dripping down the bib 20 and onto an infant's clothing or body by acting effectually as a barrier or a guard. Preferably, the bib 20 is constructed from a lightweight fabric that is preferably washable. Alternatively, the teething bib 20 may be coated with a liquid and/or food resistant liner. As can be readily recognized by one of ordinary skill in the art, alternative embodiments can be constructed of alternative conventional materials.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A teething bib, comprising:
a body portion comprising an upper portion, a lower portion, an exterior surface, a coextensive interior surface, and an outer edge therearound;
wherein said interior surface is configured to be placed against an infant's chest and torso;
said upper portion includes a pair of flaps configured to wrap and removably fasten around the infant's neck by a first fastener;
said exterior surface comprising a front portion removably fastened thereon by a second fastener that is configured to provide a second layer of protection for an infant's clothing;
said lower portion includes at least one teether configured to be placed within the infant's mouth to sooth pain from teething.

2) The teething bib of claim 1, wherein said first fastener includes a hook and loop fastener or a button fastener.

3) The teething bib of claim 1, wherein said second fastener includes a hook and loop fastener.

4) The teething bib of claim 1, wherein the body portion is substantially rectangular shaped.

5) The teething bib of claim 1, wherein said front portion is substantially rectangular shaped.

6) The teething bib of claim 1, wherein said at least one teether element are each substantially rounded protrusions.

7) The teething bib of claim 1, wherein each said at least one teether is evenly spaced apart along said lower portion.

8) The teething bib of claim 1, wherein:
said outer edge includes a thick border that is configured to bound said outer edge to prevent erosion or fraying;
said thick border being configured to prevent food, drinks, or saliva from dripping down said teething bib and onto the infant.
